(19) United States
(12) Patent Application Publication
(10) Pub. No.: US 2008/0035576 A1
(43) Pub. Date: Feb. 14, 2008

(54) CHEMICAL TREATMENT CARTRIDGE AND METHOD OF USING SAME

(75) Inventors: Saya SATOU, Tokyo (JP); Takeyuki MOGI, Tokyo (JP); Takeo TANAAMI, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 11/837,607

(22) Filed: Aug. 13, 2007

(30) Foreign Application Priority Data
Aug. 11, 2006 (JP) 2006-219442

(51) Int. Cl. B01D 15/08; B01L 11/00

(52) U.S. Cl. 210/656; 210/749; 422/101

(57) ABSTRACT

There are provided a chemical treatment cartridge capable of executing various extraction processes with ease and a method of using the same. There are formed recesses, each in a predetermined shape, in the back surface of an elastic member. The recesses create empty spaces between the cartridge substrate and the elastic member, thereby making up a well for receiving a sample, a well for pre-removing unnecessary moisture, a well for accommodating the sample at the time of distillation, a well for storing impurities therein, a well for taking out an object constituent, a flow path interconnecting the side surface of the cartridge and the well, a flow path interconnecting the well and the well, a flow path interconnecting the well and the well, a flow path interconnecting the well and the well and a flow path interconnecting the well and the well.

### FIELD OF THE INVENTION

The invention relates to a chemical treatment cartridge for executing extraction of an object constituent by transferring contents thereof due to deformation occurring thereto, upon application of an external force thereto, and a method of using the same.

### BACKGROUND OF THE INVENTION

A cartridge for chemical reaction for causing contents thereof to undergo chemical reaction by transferring the contents thereof due to deformation occurring thereto, upon application of an external force thereto, has been under development (for example, disclosed in JP 2005-37368 A). With this cartridge, an empty space for enabling chemical reaction to occur is provided therein, and the contents thereof is caused to undergo a predetermined chemical reaction, due to deformation occurring thereto, upon application of an external force thereto. According to this cartridge, a protocol for chemical reaction can be determined due to a structure itself of the cartridge while a hermetically sealed state is maintained, so that the protocol as desired can be safely executed without a personal error.

When attempting to obtain an object substance through chemical reaction, there will be, in general, the needs for removal of by-products from reaction products, and purification for extracting an object constituent having high purity. Further, when using reagents, there will be, the needs for removal of moisture in advance or an extraction process such as distillation.

However, in normal time, an extraction process such as purification and distillation requires operation works which involve a complex apparatus and takes time and labor. For example, in the case of synthesizing an object substance by chemical reaction, much time is taken for executing a process for extracting an object constituent such as isolation, purification, identification and so forth of the objective.

It is an object of the invention to provide a chemical treatment cartridge capable of executing various extraction processes with ease by utilizing a technique relating to the cartridge disclosed in JP 2005-37368 A and so forth, and a method of using the same.

### SUMMARY OF THE INVENTION

In accordance with one aspect of the invention, there is provided a chemical treatment cartridge for causing chemical treatment to proceed by transferring liquids contained therein due to deformation occurring thereto, upon application of an external force thereto, wherein said cartridge has an interior which is characterized in comprising an empty space for executing a process for extracting an object constituent from a sample accompanying liquid transfer of the sample due to deformation of the chemical treatment cartridge.

With the chemical treatment cartridge described, since the object constituent can be extracted from the sample accompanying liquid transfer of the sample due to deformation of the cartridge, the object constituent can be extracted with ease.

The interior of the cartridge may comprise an empty space for distilling the sample by heating or decompressing the sample and an empty space for accommodating the object constituent that is extracted due to distillation.

The interior of the cartridge may comprise an empty space for pre-dehydrating the sample to be distilled.

The interior of the cartridge may comprise an empty space for causing the object constituent contained in the sample to undergo recrystallization.

The chemical treatment cartridge may comprise a notch therein for taking out the object constituent from the empty space for causing the object constituent to undergo recrystallization by tearing the cartridge apart.

The interior of the cartridge may comprise an empty space for cleaning the re-crystallized object constituent.

The chemical treatment cartridge may comprise a notch therein for taking out the object constituent from the empty space for cleaning the re-crystallized object constituent by tearing the cartridge apart.

The interior of the cartridge may comprise an empty space for separating the object constituent by a chromatography and an empty space for accommodating the separated object constituent.

The interior of the cartridge may comprise a plurality of empty spaces for sequentially accommodating a plurality of object constituents that are sequentially separated by a chromatography.

In accordance with another aspect of the invention, there is provided a method of using a chemical treatment cartridge for causing chemical treatment to proceed by transferring liquids contained therein due to deformation occurring thereto upon application of an external force thereto, said method is characterized in comprising a step of extracting an object constituent from a sample accompanying liquid transfer of the sample due to deformation of the chemical treatment cartridge and a step of discarding the cartridge used in the step of extracting the object constituent.

With the method of using a chemical treatment cartridge described as above, since the object constituent can be extracted from the sample accompanying liquid transfer of the sample due to deformation of the cartridge, the object constituent can be extracted with ease. Further since the cartridge used in the step of extracting the object constituent is discarded, post-operation works such as tidying-up, cleaning, or the like will be no longer necessary while safety can be ensured.

The interior of the cartridge may comprise an empty space for distilling the sample by heating or decompressing the sample and an empty space for accommodating the object constituent that is extracted due to distillation.

The interior of the cartridge may comprise an empty space for pre-dehydrating the sample to be distilled.

The interior of the cartridge may comprise an empty space for causing the object constituent contained in the sample to undergo recrystallization.

The chemical treatment cartridge may comprise a notch therein for taking out the object constituent from the empty space for causing the object constituent to undergo recrystallization by tearing the cartridge apart.

The interior of the cartridge may comprise an empty space for cleaning the re-crystallized object constituent.

The chemical treatment cartridge may comprise a notch therein for taking out the object constituent from the empty space for cleaning the re-crystallized object constituent by tearing the cartridge apart.

The interior of the cartridge may comprise an empty space for separating the object constituent by a chromatography and an empty space for accommodating the separated object constituent.

The interior of the cartridge may comprise a plurality of empty spaces for sequentially accommodating a plurality of object constituents that are sequentially separated by a chromatography.

With the chemical treatment cartridge described as above, since the object constituent can be extracted from the sample accompanying liquid transfer of the sample due to deformation of the cartridge, the object constituent can be extracted with ease.

With the method of using a chemical treatment cartridge described as above, since the object constituent can be extracted from the sample accompanying liquid transfer of the sample due to deformation of the cartridge, the object constituent can be extracted with ease. Further, since the cartridge used in the step of extracting the object constituent is discarded, post-operation works such as tidying-up, cleaning, or the like will be no longer necessary while safety can be ensured.

### BRIEF DESCRIPTION OF THE DRAWINGS

FIG. 1 is a view showing a chemical treatment cartridge according to Embodiment 1 of the invention, in which FIG. 1(A) is a plan view of the cartridge, and FIG. 1(B) is a sectional view of the cartridge, taken on line B-B in FIG. 1(A), along wells and flow paths, respectively;

FIG. 2 is a plan view showing a chemical treatment cartridge according to Embodiment 2 of the invention;

FIG. 3 is a plan view showing a chemical treatment cartridge according to Embodiment 3 of the invention; and

FIG. 4 is a plan view showing a chemical treatment cartridge according to Embodiment 4 of the invention.

### PREFERRED EMBODIMENTS OF THE INVENTION

Embodiments of a chemical treatment cartridge according to the invention are described hereinafter.

### EMBODIMENT 1

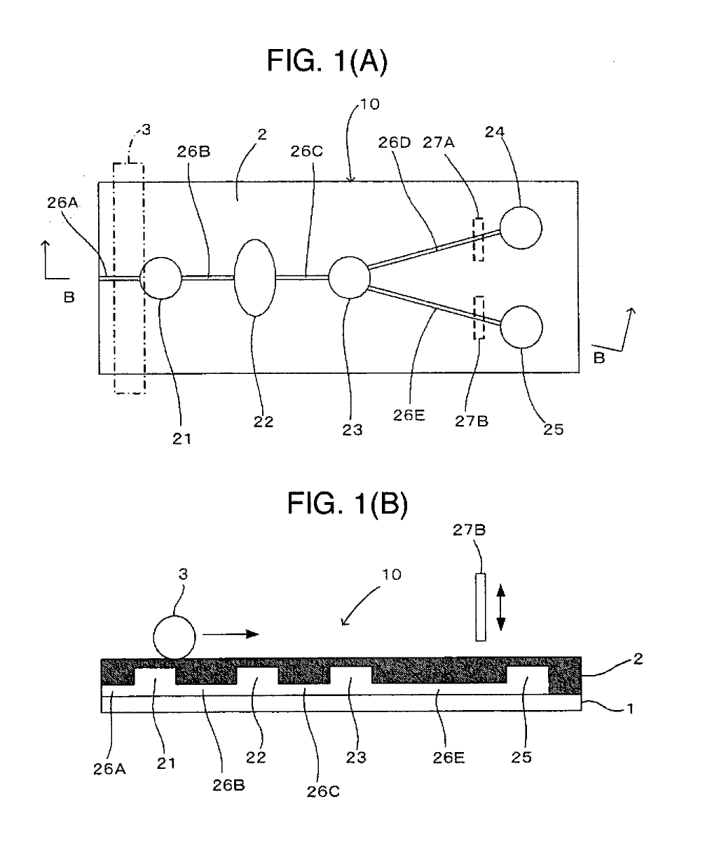

A chemical treatment cartridge according to Embodiment 1 of the invention is described hereinafter with reference to FIG. 1. The present embodiment represents a cartridge for extracting an object constituent by executing distillation under normal pressure.

FIG. 1(A) is a plan view of the cartridge according to the present embodiment, and FIG. 1(B) is a sectional view of the cartridge, taken on line B-B in FIG. 1(A), along wells and flow paths, respectively.

As shown in FIG. 1(B), a cartridge 10 according to the present embodiment comprises a cartridge substrate 1, and an elastic member 2 overlaid on the substrate 1.

Recesses formed in the back surface of the elastic member 2 shown in FIG. 1(B) create empty spaces between the cartridge substrate 1 and the elastic member 2, thereby making up a well 21 for receiving a sample, a well 22 for pre-removing unnecessary moisture, a well 23 for accommodating the sample at the time of distillation, a well 24 for storing impurities therein, a well 25 for taking out an object constituent, a flow path 26A interconnecting the side surface of the cartridge 10 and the well 21, a flow path 26B interconnecting the well 21 and the well 22, a flow path 26C interconnecting the well 22 and the well 23, a flow path 26D interconnecting the well 23 and the well 24 and a flow path 26E interconnecting the well 23 and the well 25, as shown in FIGS. 1(A), 1(B).

Described next is a distilling method by use of the cartridge 10 of Embodiment 1.

First, a sample is injected into the well 21 via the flow path 26A.

Then, when a roller 3 shown in FIG. 1(B) is pressed against the cartridge 10, the elastic member 2 undergoes deformation, thereby crushing empty space between the cartridge substrate 1 and elastic member 2. Upon rightward rotation of the roller 3, a region to crushed is shifted rightward, whereupon the sample contained in the well is shifted via the flow path 26B, thereby reaching the well 22.

Molecular sieve made of ceramics, having a predetermined minute diameter and functioning as dehydrating agent are accommodated in the well 22 in advance, so that when unnecessary moisture in the sample is removed in advance, bumping for causing accuracy of distillation to be deteriorated is prevented.

Then, upon further rotation of the roller 6 rightward, the sample reaches the well 23 via the well 26C.

Subsequently, a valve member 27B is caused to pressed against the cartridge 10, thereby causing the elastic member 2 to undergo elastic deformation to render the flow path 26E in a closed state, wherein the well 23 is heated from the outside of the cartridge 10. Further, the flow paths 26D and 26E are cooled by water cooling and so forth from the outside of the cartridge 10. As a result, the sample is vaporized to enter the flow paths 26D and 26E, and is cooled and returns to the well 23 as a liquid, which operations are repeated, so that low boiling point impurities contained in the sample reach the well 23 or well 24 via the flow path 26D on the principle of distillation at normal temperature, and removed.

Then, after the temperature in the well 23 is stabilized at a boiling point of an object constituent, a valve member 27A is pressed against the cartridge 10 to close the flow path 26D, while the valve member 27B is kept away from the cartridge 10 to release the flow path 26E. As a result, the object constituent starts to shift toward the well 25. Then, upon start of recovery of the object constituent, before the temperature in the well 23 exceeds the boiling point of the object constituent, the flow path 26E is closed by the valve member 27B to stop the heating in the well 23. A high boiling constituent other than the object constituent remains in the well 23. Meanwhile, the temperature in the well 23 can be monitored by use of a variety of temperature sensors.

With the procedures mentioned above, the object constituent can be recovered in the well 25, the object constituent can be a sampled from the well by use of the syringe or the like.

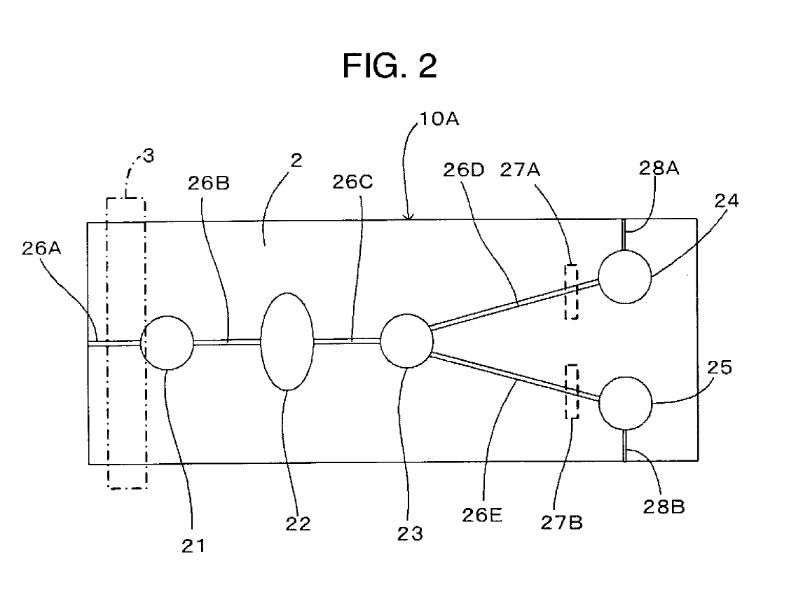

A chemical treatment cartridge according to Embodiment 2 of the invention is described hereinafter with reference to FIG. 2. The present embodiment represents a cartridge for extracting an object constituent by executing distillation under reduced pressure. Described hereinafter is the difference between the Embodiments 1 and 2.

### EMBODIMENT 2

FIG. 2 is a plan view of a chemical treatment cartridge according to Embodiment 2.

As shown in FIG. 2, there are formed in a chemical treatment cartridge 10A (hereinafter simply referred to as cartridge) a connection hole 28A interconnecting a side surface of the cartridge 10A and a well 24 and a connection hole 28B interconnecting the side surface of the cartridge 10A and a well 25.

With the cartridge 10A of the present embodiment, on the occasion of distillation, respective wells 23, 24, 25 are reduced in pressure via the connection holes 28A and 28B, thereby decreasing a boiling point of a sample. As a result, a heating temperature of the well 23 can be reduced, so that the object constituent can be extracted even in the case where the sample has a high boiling point or the object constituent is prone to be thermally decomposed. Meanwhile, other procedures on the occasion of distillation are the same as those of Embodiment 1.

### EMBODIMENT 3

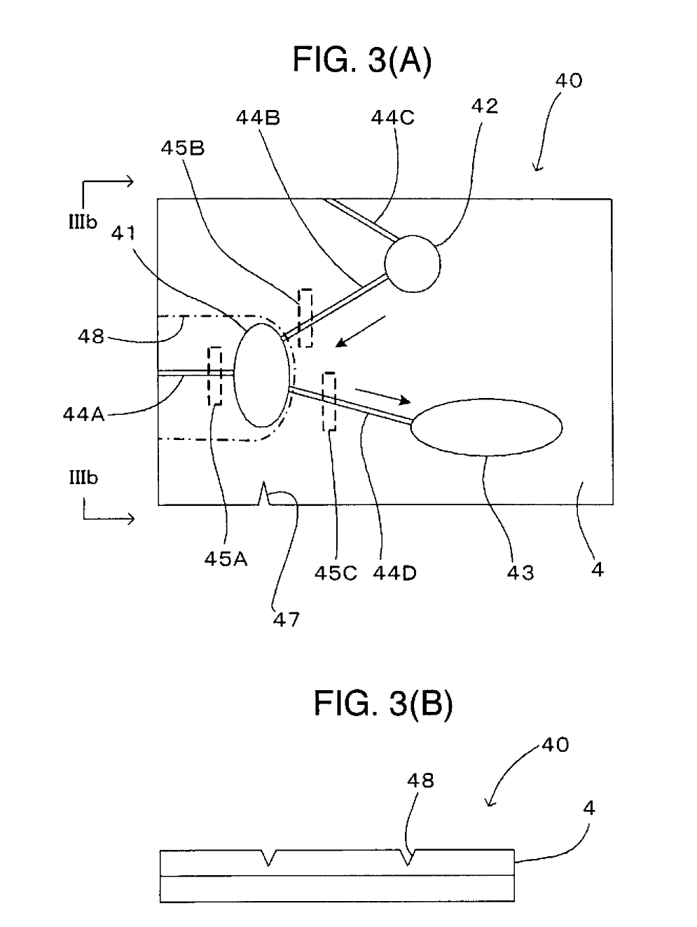

A chemical treatment cartridge according to Embodiment 3 of the invention is described hereinafter with reference to FIG. 3. The present embodiment represents a cartridge for extracting an object constituent by executing recystallization.

FIG. 3(A) is a plan view of a cartridge according to Embodiment 3 and FIG. 3(B) is a side view as viewed from the line IIIb-IIIb in FIG. 3(A).

As shown in FIG. 3(A) and FIG. 3(B), a cartridge 40 of the present embodiment has a substrate (not shown) and an elastic member 4 formed of a gas-permeable elastic body, like a PDMS (polydimethylsiloxane) overlaid on the substrate.

Recesses, each in a predetermined shape, are formed in the back surface of the elastic member 4. The recesses create empty spaces between the cartridge substrate and the elastic member 4, thereby making up a well 41 for receiving a sample, a well 42 for cleaning the sample with solvent, a well 43 for accommodating discarded liquid therein, a flow path 44A interconnecting the side surface of the cartridge 40 and the well 41, a flow path 44B interconnecting the well 41 and the well 42, a flow path 44C interconnecting the side surface of the cartridge 40 and the well 42, and a flow path 44D interconnecting the well 41 and the well 43, respectively, as shown in FIG. 3(A).

Described next is a method of extracting the object constituent by use of the cartridge 40 according to the present embodiment.

First, the sample is dissolved in excess amounts of solvent near to saturation. Next, a liquid solvent is injected in the well 41 via the flow path 44A by use of a syringe or the like.

Then, when a valve member 45A, a valve member 45B and a valve member 45C are pressed against the cartridge 40, respectively, thereby causing the elastic member 4 to undergo elastically deformation to close the flow path 44A, flow path 44B and flow path 44D, as shown in FIG. 3(A). Upon keeping this state, a solvent is gently evaporated with the lapse of time, so that nucleus which becomes crystal is generated. Meanwhile, the solvent permeates the elastic member 4 owing to permeability to gas of PDMS, and it is gradually evaporated.

A crystal of the object constituent is gown (re-crystallized) in the well 41 with the evaporation of the solvent, and the crystal and impurities are dissolved to be rendered in a mixed state.

Next a solvent which is the same as the solvent which dissolved the sample is injected in the well 42 via the flow path 44C. Thereafter, the valve member 45B is kept away from the cartridge 40 to release the flow path 44B alone, whereby a roller which is pressed against the cartridge 40 is shifted along the flow path 44B so that the solvent inside the well 42 is introduced into the well 41. The re-crystallized object constituent is cleaned by the solvent newly introduced into the well 41.

Subsequently, the flow path 44C is closed again by the valve member 45B and the valve member 45C is kept away from the cartridge 40 to release the flow path 44C. In this state, the roller pressed against the cartridge 40 is shifted along the well 41 and flow path 44C so that the solvent (discarded liquid) inside the well 41 is discharged toward the well 43.

Since the crystal as cleaned remains in the retainer well 41, the object constituent can be taken out by tearing the cartridge 40 apart. A notch 47 is provided in the cartridge 40 and the cartridge 40 may be torn apart from the notch 47 toward the well 41. Further, a notch groove 48 for encompassing the well 41 is formed in the elastic member 4 and the cartridge 40 may be torn apart along the notch groove 48.

### EMBODIMENT 4

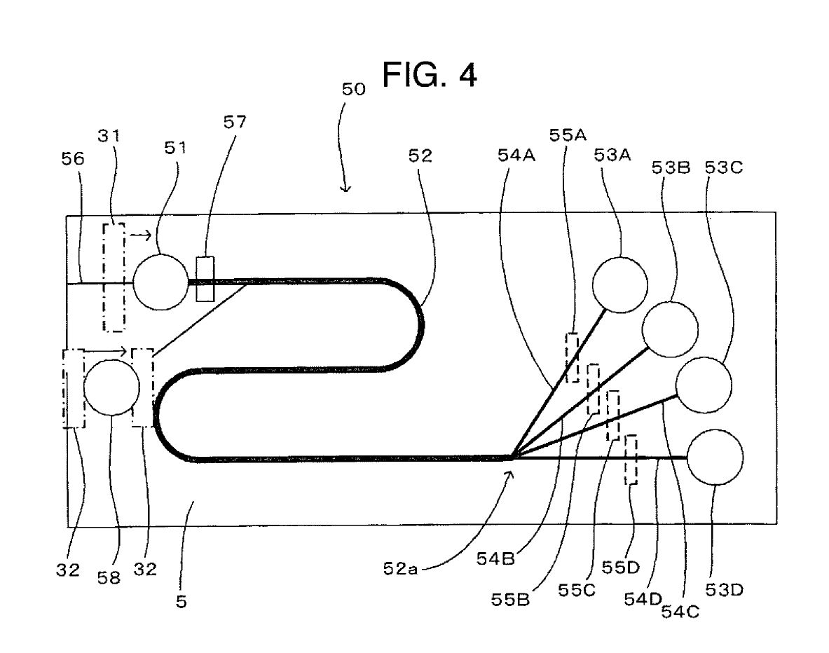

A chemical treatment cartridge according to Embodiment 4 of the invention is described hereinafter with reference to FIG. 4. The present embodiment represents a cartridge for executing separation and extraction of an object constituent by a column chromatography.

FIG. 4 is a plan view of a cartridge according to the present embodiment.

As shown in FIG. 4, a cartridge 50 of the present embodiment comprises a substrate (not shown) and an elastic member 5 overlaid on the substrate like Embodiment 1.

Recesses, each in a predetermined shape are formed in the back surface of the elastic member 5. The recesses create empty spaces between the cartridge substrate 1 and the elastic member 5, thereby making up a well 51 for receiving a sample, a column 52 which is filled with silica grain, a well 53A, a well 53B, a well 53C and a well 53D for accommodating each constituent separated by the column 52, a flow path 54A, a flow path 54B, a flow path 54C, a flow path 54D interconnecting between the well 53A, well 53B, well 53C, well 53D and the column 52, respectively, and a flow path 56 interconnecting the side surface of the cartridge 50 and the well 51, as shown in FIG. 4.

Described next is a method of separating and extracting the object constituent by use of the cartridge 50 of Embodiment 4.

First, a liquid sample is injected into the well 51 via the flow path 56 by use of a syringe or the like. At this point in time, the flow path 54A, flow path 54B, flow path 54C and flow path 54D are closed by a valve member 55A, a valve member 55B, a valve member 55C and a valve member 55D.

Then, in a state where a valve member 57 is kept away from the cartridge 50, a roller 31 pressed against the cartridge 50 is shifted from the well 51 toward the column 52 so that a sample inside the well 51 is shifted toward the column 52 to be adsorbed to a silica.

Subsequently, an origin of the column 52 is closed by the valve member 57 and development solvent contained in the well 58 is transferred by a roller 32, thereby applying a constant pressure to the sample.

The sample to which the pressure is applied is shifted in the column, so that respective constituents of the sample are separated gradually by a chromatography according to a difference in polarity of the constituents.

When a first constituent intended to be extracted reaches a destination 52a of the column 52 (FIG. 4), the valve member 55A is kept away from the cartridge 50 to release the flow path 54A alone, so that the first constituent reached the destination 52a is introduced into the well 53A via the flow path 54A. Thereafter, the flow path 54A is closed again by the valve member 55A.

Next, when a second constituent intended to be extracted reaches a destination 52a of the column 52 (FIG. 4), the valve member 55B is kept away from the cartridge 50 to release the flow path 54B alone, so that the second constituent reached the destination 52a is introduced into the well 53B via the flow path 54B. Thereafter, the flow path 54B is closed again by the valve member 55B.

By repeating the foregoing procedures, the constituents intended to be extracted can be sequentially introduced into the well 53A, well 53B, well 53C and well 53D.

The extracted constituents extracted in the well 53A, well 53B, well 53C and well 53D can be taken out by use of the syringe or the like.

Since the cartridge 50 is disposable according to the present embodiment, there is no likelihood of flying of silica grains filled in the column 52 so that safety can be ensured. Further, according to the present embodiment, since the column 52 can be miniaturized, the amount of use of silica grains can be controlled.

According to the present embodiment, although the liquid sample is carried out under a pressure, it may be transferred under a gravity by forming or disposing the column in the direction where the gravity acts on.

As described in the foregoing, according to the chemical treatment cartridge of the invention, an algorism for extracting constituents is prescribed in advance depending on the configuration of the cartridge. Accordingly, fail or loss can be repressed, and the difference in technique of an operator who handles the cartridge is hardly visible so that correct extracting procedure can be at all times realized. It is also possible to prevent inadvertent accident from being occurred. Further, preparation for an extraction process is simple, thereby drastically reducing time and labor for the extraction process. Further, expensive instrument for executing distillation and separation of the object constituent which had been required so far will be no longer necessary. Still further, since the cartridge is disposable, post-operation works such as cleaning of instrument, or the like will be no longer necessary while safety can be ensured.

Further, since the cartridge is kept in an airtight state, and hence, for example, it can be kept in an anaerobic state, which is suitable for keeping the object constituent and purified substance. Still further, since the solvent and other substance which arises a problem in keeping condition and indispensable to extraction operation can be contained in the cartridge in advance, an operation before extraction operation can be reduced.

The chemical treatment cartridge of the invention can be widely applied to extraction of reagents and so forth for a test. Further, the chemical treatment cartridge can be also applied to manufacture and extraction of chemicals, reagents and other chemical constituents.

The scope of application of the invention is not limited to the foregoing embodiments. The invention can be widely applied to a chemical treatment cartridge for executing extraction of an object constituent by transferring contents thereof due to deformation occurring thereto, upon application of an external force thereto, and a method of using the same.

What is claimed is:

1. A chemical treatment cartridge for causing chemical treatment to proceed by transferring liquids contained therein due to deformation occurring thereto, upon application of an external force thereto, wherein said cartridge has an interior comprising:
an empty space for executing a process for extracting an object constituent from a sample accompanying liquid transfer of the sample due to deformation of the chemical treatment cartridge.

2. The chemical treatment cartridge according to claim 1, wherein the interior of the cartridge comprises:
an empty space for distilling the sample by heating or decompressing the sample; and
an empty space for accommodating the object constituent that is extracted due to distillation.

3. The chemical treatment cartridge according to claim 2, wherein the interior of the cartridge comprises an empty space for pre-dehydrating the sample to be distilled.

4. The chemical treatment cartridge according to claim 1, wherein the interior of the cartridge comprises an empty space for causing the object constituent contained in the sample to undergo recrystallization.

5. The chemical treatment cartridge according to claim 4, wherein the chemical treatment cartridge comprises a notch therein for taking out the object constituent from the empty space for causing the object constituent to undergo recrystallization by tearing the cartridge apart.

6. The chemical treatment cartridge according to claim 4, wherein the interior of the cartridge comprises an empty space for cleaning the re-crystallized object constituent.

7. The chemical treatment cartridge according to claim 6, wherein the chemical treatment cartridge comprises a notch therein for taking out the object constituent from the empty space for cleaning the re-crystallized object constituent by tearing the cartridge apart.

8. The chemical treatment cartridge according to claim 1, wherein the interior of the cartridge comprises an empty space for separating the object constituent by a chromatography and an empty space for accommodating the separated object constituent.

9. The chemical treatment cartridge according to claim 8, wherein the interior of the cartridge comprises a plurality of empty spaces for sequentially accommodating a plurality of object constituents that are sequentially separated by a chromatography.

10. A method of using a chemical treatment cartridge for causing chemical treatment to proceed by transferring liquids contained therein due to deformation occurring thereto upon application of an external force thereto, said method comprising:
a step of extracting an object constituent from a sample accompanying liquid transfer of the sample due to deformation of the chemical treatment cartridge; and
a step of discarding the cartridge used in the step of extracting the object constituent.

11. The method of using a chemical treatment cartridge according to claim 10, wherein the interior of the cartridge comprises:
an empty space for distilling the sample by heating or decompressing the sample; and
an empty space for accommodating the object constituent that is extracted due to distillation.

12. The method of using a chemical treatment cartridge according to claim 11, wherein the interior of the cartridge comprises an empty space for pre-dehydrating the sample to be distilled.

13. The method of using a chemical treatment cartridge according to claim 10, wherein the interior of the cartridge comprises an empty space for causing the object constituent contained in the sample to undergo recrystallization.

14. The method of using a chemical treatment cartridge according to claim 13, further comprising a step of taking out the object constituent from the empty space for causing the object constituent to undergo recrystallization by tearing the cartridge apart.

15. The method of using a chemical treatment cartridge according to claim 14, wherein the interior of the cartridge comprises an empty space for cleaning the re-crystallized object constituent.

16. The method of using a chemical treatment cartridge according to claim 15, further comprising a step of taking out the object constituent from the empty space for cleaning the re-crystallized object constituent by tearing the cartridge apart.

17. The method of using a chemical treatment cartridge according to claim 10, wherein the interior of the cartridge comprises an empty space for separating the object constituent by a chromatography and an empty space for accommodating the separated object constituent.

18. The method of using a chemical treatment cartridge according to claim 17, wherein the interior of the cartridge comprises a plurality of empty spaces for sequentially accommodating a plurality of object constituents that are sequentially separated by a chromatography.
